(19) United States
(12) Patent Application Publication
(10) Pub. No.: US 2026/0310824 A1
(43) Pub. Date: Oct. 8, 2026

(54) SYSTEMS AND METHODS FOR DISTRIBUTED DATA QUERIES USING OBSCURED PERSONAL DATA

(71) Applicant: Capital One Services, LLC, McLean, VA (US)

(72) Inventors: Kevin Osborn, Newton Highlands, MA (US); Narmeen Rahman, Brooklyn, NY (US); John Jones, Leesburg, VA (US); Linda Yu, New York, NY (US)

(21) Appl. No.: 19/173,515

(22) Filed: Apr. 8, 2025

(51) Int. Cl. G06F 21/62; G06F 16/2453; G06Q 20/34

(52) U.S. Cl. CPC G06F 21/6254; G06F 16/24532; G06Q 20/352

(57) ABSTRACT

The disclosed systems and methods are directed to an implementation of non-transparent data query with a switchboard system linking multiple service-providing and client entities. A source device, initiating a user-related data query, may canonicalize and obscure a user identification record(s) prior to transmitting it, along with a data request, to the switchboard system. In one embodiments a cache of session data collected from previous contactless card transactions may be used to quickly determine a set of contactless payment options that are available to the user. If no identification is determined from the cache, the switchboard references its issuers database and generates a distributed query with the obscured data which is then disseminated among recipient issuing entities in accordance to one or more optimization criteria. The results returned from the queried switchboard members may then be processed and returned result to the query-initiating switchboard member (e.g., a merchant client entity).

The present disclosure is generally related to distributed data query implementation, and more specifically to systems and methods for distributed data query implementation based on obscured personally identifiable user data.

### BACKGROUND

Implementation of a distributed query system for various user-related information generally involves exposure of personally identifiable information related to a user, such as email address and/or a phone number. In order to avoid privacy and security concerns, it is generally a good practice to avoid unnecessary exposure of such personal user data. However, in distributed systems any inquiries regarding a user's eligibility information, for example, for curating set of option provided to a user, is contingent upon identifying the user in order for associated information to be identified from one or more data repositories. As noted, this may result in unnecessary exposure of user personal data to fraudulent parties.

These and other deficiencies exist. Therefore, in order to prevent unnecessary exposure of user personal data to fraudulent parties, there is a need for non-transparent implementation of user identification for the purpose of querying relevant information in a distributed manner.

### SUMMARY OF THE DISCLOSURE

In some aspects, the techniques described herein relate to a method for determining user eligibility from obscure personal data, the method comprising: transmitting, by a first client entity, a data request message comprising an obscured user identification record to a switchboard communicatively coupled to a plurality of service providers; comparing, by the switchboard, the obscured identification record with a plurality of user identifiers in a cache repository of transactional data stored by the switchboard; transmitting, responsive to detecting one or more cache hits with the obscured user identification records, one or more data records associated with matching user identifiers in the cache repository, to the first client entity; responsive to detecting a cache miss, identifying, based on the data request message, a list of target service providers from a member database associated with the switchboard; ordering the list of target service providers into one or more sets of service providers based on geographical proximity to a geographical location of the first client entity; transmitting, by the switchboard, a first batch of parallel queries, with the obscured user identification record, to a first set service providers from the one or more sets of service providers; transmitting, by the switchboard and based on a query optimization criteria determined from one or more query responses received from the first set of service providers, one or more batches of parallel queries, with the obscured user identification record, to the one or more sets of service provider; transmitting, by the switchboard, a response message to the first client entity, the response comprising one or more query results received from one or more sets of queried service providers.

In some aspects, the techniques described herein relate to a system for determining user eligibility from obscured personal data, the system comprising: a switchboard communicatively coupled with a plurality of client and service provider entities, wherein the switchboard is configured to: receive, from a first client entity, a data request message comprising an obscured user identification record, wherein the identification record is canonicalized according to first canonicalization format prior to obscuration; compare the obscured identification record with a plurality of user identifiers in a cache repository of transactional data stored by the switchboard; transmit, responsive to detecting one or more cache hits with the obscured user identification records, one or more data records associated with matching user identifiers in the cache repository, to the first client entity; responsive to detecting a cache miss, identify, based on the data request message, a list of target service providers from a member database associated with the switchboard; order the list of target service providers into one or more sets of service providers based on geographical proximity to a geographical location of the first client entity; transmit a first batch of parallel queries, with the obscured user identification record, to a first set service providers from the one or more sets of service providers; transmit based on a query optimization criteria determined from one or more query responses received from the first set of service providers, one or more batches of parallel queries, with the obscured user identification record, to the one or more sets of service provider; transmit a response message to the first client entity, the response comprising one or more query results received from one or more sets of queried service providers.

### BRIEF DESCRIPTION OF THE DRAWINGS

FIG. 1 illustrates a system implementation for user eligibility determination based on obscured user data, according to an example embodiment.

FIG. 2 illustrates a process flow diagram for implementation of user eligibility determination based on obscured user data, according to an example embodiment.

FIG. 3 illustrates a process flow diagram for query optimization based on an expanding query space, according to an example embodiment.

FIG. 4 illustrates a timing sequence for query optimization based on a contracting query space, according to an example embodiment.

FIG. 5 illustrates an exemplary switchboard system implementation, according to an example embodiment.

FIG. 6 illustrates a block diagram of an exemplary system, according to an example embodiment.

### DETAILED DESCRIPTION

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

One aspect of the present disclosure is directed to operations of a distributed management platforms linking multiple member entities comprising of service-requesting (e.g., a client entity) and service-providing (e.g., account issuers) entities. The distributed management platform may provide various services to its member entities. For example, in one embodiment, a client entity may transmit a request for one or more user-related information to the distributed management platform. The distributed management platform may then process the request based on one or more internal operations and external communications with its member entities and provide the requesting client entity with the requested information. The client entity may correspond to a merchant. The client may wish to incorporate a checkout feature that present a user with payment options that correspond to account privileges and transaction instruments available to the user. Accordingly, in order to determine a set of appropriate checkout options that may be presented to a user for completion of a transaction (e.g., at an online payment site and/or platform, and/or a merchant checkout page) the merchant entity, participating on the distributed management platform, may transmit a request, for eligible accounts and payment instruments to which the user has access, to the distributed management platform. If the distributed management platform cannot fulfill the request based on its internally accessed data, a query, for the requested information, may be issued to various participating service providers, each of which may serve a plurality of users having various account privileges and distinct transaction instruments. In one embodiment, the requested user-related information may correspond to valid contactless card accounts associated with the user, in order to facilitate presentation of contactless payment options to the user at checkout. However, such distributed queries may involve distribution of one or more user identification records, which may risk unnecessary exposure of user personally identifiable information (PII) to unauthorized or fraudulent actors. As such, one aspect of the present disclosure is directed to a non-transparent implementation for querying relevant user information from a plurality affiliated member entities (e.g., banks and/or financial or other institutions) participating on a distributed management platform. In accordance to one embodiment, personally identifiable information (PII) associated with a user is obscured prior to dissemination to protect user privacy and prevent unnecessary exposure of personal identification data to fraudulent parties. For example, user PII records may be converted to a scrambled or obscured version of the same that would be comparable with correspondingly scrambled or obscured versions of user PII data records maintained by member service providers associated with various user accounts.

A general difficulty with systems and methods associated with anonymous and/or partially obscured data is that the PII still needs to be recognized by a verifying service provider. Accordingly, in one embodiment, user PII data may be canonicalized prior to being obscured, thus enabling a degree of non-transparent comparison that can be performed between a queried data element and obscured data records maintained by various member service provider entities. A consistent canonicalization format for user PII records may be negotiated among various member entities (e.g., participating service providers and client entities) and maintained across all members.

In accordance to one embodiment, same set of data canonicalization and obscuration rules are implemented on both the client entities (e.g., a merchant system sourcing a user eligibility query), and the service providers (e.g., various account-issuing and/or financial institutions) such that data elements that are that are being compared are canonicalized according to a set same of rules. Accordingly, similarly obscured data (pertaining to user PII in client request message and stored user PII records maintained by one or more service provider systems) may be compared for determining a match. In some embodiments, the cached data associated with previous contactless card transaction stored in a cache repository of the distributed management platform, is canonicalized and obscured in a same manner as the client-side process that forwarded the PII data along with a query request to the distributed management platform.

In one embodiments of the present disclosure, a distributed management platform, is implemented with a switchboard system. Exemplary switchboard implementation may be configured to facilitate non-transparent querying of transactional options available to a user. One example scenario may involve a user that has landed on a merchant checkout webpage. An administering merchant server may then generate a pre-authorization query for eligible user accounts among participating member entities (e.g., account issuing entities). In accordance to one embodiment, performing the query in a non-transparent way (e.g., to avoid unnecessary exposure of user's personal identification data) entails that user identification data is canonicalized and obscured prior to being forwarded to the switchboard system.

The context of query being generated by a client entity (e.g., a merchant payment system) and distributed, via the switchboard, among participating switchboard members, depends upon a type of user eligibility that is to be determined. For example, a query may be purposed to identify one or more user payment accounts associated with a contactless transaction card. For example, a client service may want to improve usability of their electronic user interface by including a feature that displays a selection of contactless payment options available to a transacting user. The client service entity therefore issues a query, for contactless payment instruments associated with the user, to the switchboard system on which it is member. As noted above, in order to prevent unwanted exposure of personal user identification data, the query may be indexed by an obscured user identification record. Upon receiving the request, the switchboard then distribute the query to the plurality of member service-providers (issuing entities) based on one or more optimization criteria described in further details below. Based on query responses coming back from the member entities, the switchboard process may return one or more eligible contactless card accounts associated with the user. The client system/service may then provide the user an option for checking out by tapping a specific contactless card or any one of the one or more contactless cards available to the user and which are on the checkout page (e.g., graphical/iconized rendition of the card image and/or issuing entity identification.

As described above, with respect to some embodiments of the disclosure, prior to issuing a distributed query to its member entities, the switchboard may first access an internal cache of data records corresponding to previously recorded transactional activities from different users. The cached data records may be indexed with obscured user identifiers associated with a corresponding user. If the user identifiers are formatted in accordance to issuer version of a customer's personal information (e.g., canonicalized and obscured with a format consistent with a client system sourcing the request message) a rapid comparison of the obscured user identification data, included in the eligibility request, with previously cached information from contactless card transactions can be carried out. This may enable the switchboard process to promptly identify one or more contactless card accounts associated with an obscured user PII and return the results back to the client entity that had initiated the request (e.g., a request for eligible contactless card account associated with the user).

Therefore, in some instances, the identifications of a user's transactional options may be directly determined based on a cached record of contactless card activity data, stored on the switchboard system. In such cases, wherein a record of contactless transaction card activity, in association with the obscured user PII, is identified in the cache repository of the switchboard, there may not be a need for querying the switchboard member entities with the obscured user PII data received from the first client entity. The switchboard may examine the cache data repository of prior card-tapping activity for a match with the obscured PII data provided in an eligibility request sourced from a client entity. If a cache hit is detected, the switchboard process provides a listing of user transaction cards eligible for contactless operation to the client entity for presentation to the user (e.g., for display on a checkout interface). However, if a cache hit is not identified, the switchboard process may generate a distributed query, for the obscured user identification data among, among the participating switchboard member entities. In preparation for issuing a distributed query to determine user's eligibility (e.g., one or more contactless card accounts associated with the user), a geographic location of the request source may be identified by a switchboard process (e.g., from a source IP address). In some embodiments, a geographical location indicator may be provided, along with the request message, by the requesting client entity.

The switchboard client entity generating and transmitting the initial request to the switchboard system may be associated with a secure online access platform and/or a merchant payment/checkout site. As described in accordance to some embodiments of the disclosure, the source device may canonicalize and obscure a user identification record(s) prior to transmitting it to the switchboard system. In one embodiments a cache of session data collected from previous contactless card transactions may be used to quickly determine a set of contactless payment options that are available to the user. If no identification is determined from the cache, the switchboard references its member database and generates a distributed query with the obscured data which is then disseminated among recipient issuing entities in accordance to one or more optimization criteria. The results returned from the queried switchboard members may then be processed and returned to the requesting switchboard member (e.g., a merchant client entity).

For the purpose of optimizing the distributed query, the switchboard process may conduct a logical ordering of the recipient member entities based on geographic location data of the requesting source entity. Accordingly, in one embodiment, the receiving switchboard process may issue batches of parallel queries with the obscured user PII data elements. The batches of parallel queries may be disseminated, by the switchboard process, in accordance to the determined order. The results returned by the queried members is then streamed to the source client. The result may correspond to various contactless card account associated with a user (as identified from the obscured user identification data). The dissemination of the distributed query may be implemented using dynamic batch sizes, with the batch size depending upon responses returned from the queried switchboard members (e.g., account issuing entities). For example, multiple null responses (e.g., no user records matching the obscured user PII included as a query index) may initiate the switchboard process to expand the geographical scope of the query distribution. In some embodiments the switchboard process may progressively widen and/or narrow the search space of queries going out to member issuing entities (e.g., banks) depending on the number of positive hits and null hits returned from each set of queried member entities. As described earlier, a common standard and/or protocol for canonicalization and obscuring of the user PII may be negotiated among the switchboard members.

In accordance to some embodiments, incorporation of a fuzzy matching mechanism may enable the processing partial matches to the obscured user PII data, returned in response to a distributed query, in order to synthesize a probabilistic determination of eligibility from obscured user identification data. for example, if a user is registered with multiple service providers with different email addresses there may be a partial match between the obscured identifier associated with the eligibility query and obscured user records maintained by one or more switchboard member entities. In one embodiments a switchboard process may narrow the scope of results involving a plurality of partial matches by including other search factors/criteria that are not related to personal user information and can therefore be passed in clear text. One example of a clear text data may correspond to a source location of a query determined based on an IP address of a source device/system. Such supplementary query data may be circulated in clear text to facilitate further optimization in determining a correct match from plurality of partial matches (and/or matches between partially obscured data records). In some embodiments, a confidence score (based on confluence of factors) maybe provided based on combining obscure and clear-text data.

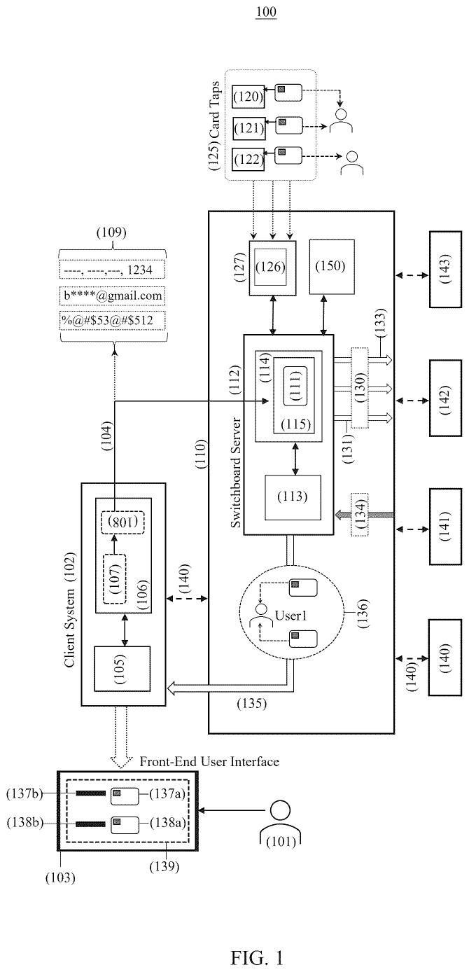

FIG. 1 illustrates an example system implementation 100. Although FIG. 1 illustrates single instances of components of system 100, system 100 may include any number of components. The exemplary system implementation 100 illustrates a distributed management platforms (e.g. switchboard system 110) communicatively coupled with a plurality of member entities participating on the switchboard system 110. The plurality of member entities may comprise a plurality of service providers and/or account-issuing entities (e.g., 140-143) and a plurality of client entities (e.g., requesting client entity represented by client-side system and/or server). Referring back to example 100, a user 101 has landed on a checkout page 103 of a website associated with client system 102 (e.g., the checkout page may be associated with a secure online access platform, such as google and/or a merchant payment/checkout site). The client system 102 may be running a front-end user interface 139 with a feature for visually representing contactless payment options available to a user (e.g., user 101) to streamline the checkout process. In order to determine one or more eligible contactless payment accounts associated with the user, the client system 102 generates a request 104 (e.g., an eligibility request) for the required information. With respect to example 100, the request 104 may pertain to contactless payment accounts associated with the user 101. The request for eligible user accounts is then transmitted to the switchboard system 110.

The client system 102 may include a processor 105 and memory 106. Memory 106 may include one or more applications, such as client-side processes 107 and 108, which may be executed by the processor 105 to execute one or more applications that enable, for example, network and/or data communications with one or more components of system 100, as well as the functions described herein. Upon execution by the processor 105, the applications may provide the functions described in this specification, specifically to execute and perform the steps and functions in the process flows described below. Such processes may be implemented in software, such as software modules, for execution by computers or other machines. The applications may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

Without limitation, the client system 102 may be a network-enabled computer. As referred to herein, a network-enabled computer may include, but is not limited to, a server, a network appliance, a personal computer, a workstation, a phone, a handheld PC, a personal digital assistant, a contactless card, a thin client, a fat client, an Internet browser, a kiosk, a tablet, a terminal, an ATM, or other device. The client system 102 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The client system 102 may include processing circuitry and may contain additional components, including processors, memories, error and parity checkers, data encoders, anticollision algorithms, controllers, command decoders, security primitives and tamper-proofing hardware, as necessary to perform the functions described herein. The client system 102 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touchscreen, keyboard, mouse, cursor-control device, touchscreen, microphone, digital camera, video recorder or camcorder. These devices may be used to enter information and interact with the software and other devices described herein.

Referring back to the exemplary implementation 100, in order to prevent unnecessary exposure of a user's personally identifiable information (PII), user identification record(s) included in the request message 104 may be canonicalized and obscured prior to being included in the switchboard request message 104. In the illustrated example 100, canonicalization of a user PII records is performed by a client-side process 107, the output of which is obscured or scrambled by another client-side process 108. In some embodiments the canonicalization and obscuring of user PII data records may be performed by a same client-side process and/or by an external process (e.g., a process not administered by the client system) communicatively coupled to the client system 102 and/or switchboard system 110. Obscured PII records 109 provides some examples of the canonicalized and obscured user identification records included in the switchboard request message 104.

The switchboard request message 104 is transmitted to the switchboard system 110 and may be received by a first switchboard process 111. The first switchboard process 111 may be running on a switchboard server 112. Initially the receiving switchboard process 111 may check with a cached data repository 127 associated with previously recorded transactional activity 125 from various users, as received from one or more client member entities (e.g., client devices and/or systems 120-122). The data records 126 stored in the cache repository 127 may be canonicalized and obscured in a same manner as performed by the requesting client-side processes 107 and 108. The canonicalization and obscuring of the cached data records 126 may be performed by the source client entities (e.g., 120-122) or a process running on the switchboard system 110.

Accordingly, the receiving switchboard process 111 may first access cached data records 126 for identifying a match with the obscured PII data (e.g., one or more of data records 109 included in the switchboard request 104) provided, by the client entity 102, in the switchboard request 104. The cached data records 126 may comprise data retrieved from previous contactless card transactions (e.g., card-tapping activity 125). If a cache hit, corresponding to successful identification of a cached user PII matching the obscured user PII data in the request message 104, is detected by the switchboard process 111, one or more contactless card accounts associated with the matching user PII may be returned back in response to the switchboard request 104 (e.g., a request for eligible contactless card account associated with the user). If a cache hit is not identified, the switchboard process 111 may initiate a distributed query 130 including the obscured user PII record(s) (e.g., one or more of data records 109), via parallel batches 131-133 to one or more groups of member service providers (e.g., issuing entities 140-143 participating on the switchboard system 110).

The distribution and dissemination of the user eligibility query 130 may be based on one or more optimization criteria. For example, the switchboard board system 110 may maintains a database of its member entities (e.g., database 150). A geographical location of the source client (e.g., client system 102) generating the switchboard request 104 may be determined from, for example, an internet protocol (IP) address of the source entity (e.g., client system 102) associated with the received switchboard request 104. Based on the determined location of the request source, a geographical mapping of regionally and nationally affiliated member entities (e.g., financial institutions), identified from a member entity database 150, may be generated by a switchboard process. For example, the switchboard process 111 may query its issuer/member database 150 for contactless card issuers and order the identified list of the issuers in accordance to national and regional banks located within regions and sub-regions encompassing the source location. The switchboard process may then iterate through the list and issue batches of parallel queries, with the obscured user PII data record(s), to national and/or regional institutions operating within a region, a subregion, and/or one or more neighboring subregions based on one or more optimization criteria. The switchboard process may then expand or narrow the search scope based on responses received from the queried member entities. For example, in some embodiments, the switchboard process may increase its query batch size 130 (e.g., from a current subregion to neighboring subregions and/or the region as a whole), if multiple empty/null responses are returned. Similarly, the switchboard process may decrease its query batch size 130 if it received multiple non-empty responses.

Based on responses 134 returned from the queried member entities, the switchboard process 111 may transmit a request response 135 to the requesting client (e.g., client system 102). The request response 135 may comprise data identifying one or more user payment accounts associated with a contactless transaction card (as indicated, for example, by illustrated representation 136). The client system/service 102 may then provide the user an option for checking out by tapping a specific contactless card or any one of the one or more contactless cards available to the user. In accordance to one embodiment, the options may be displayed, on a user interface feature 139 associated with the checkout page 103, as graphical and/or iconized rendition of the card images (e.g., card icons 137a, 138a) and/or issuing entity identification data (e.g., 137b, 138b).

As described above, with reference to FIG. 1, the requesting client system 102 may correspond to a point of sale (POS) device for receiving and processing payment transactions associated with purchase and/or payment operations at a merchant. The client system 102 may therefore correspond to any device associated with transaction-side operations, such as a POS device. The client system 102 may further comprises a processor 105 and memory 106 storing one or more applications for processing received user identification data into canonicalized and obscured identification records.

The server 112 may be a switchboard-implemented server for receiving and processing the switchboard request message comprising obscured user identification data from the client device/system 102. The switchboard server 112 may be a network-enabled computer device. Exemplary network-enabled computer devices include, without limitation, a server, a network appliance, a personal computer, a workstation, a phone, a handheld personal computer, a personal digital assistant, a contactless card, a thin client, a fat client, an Internet browser, a mobile device, a kiosk, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The switchboard server 112 may include a processor 113, a memory 114, and one or more applications 115. The processor 113 may be a processor, a microprocessor, or other processor, and the server 112 may include one or more of these processors. The processor 113 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 113 may be coupled to the memory 114. The memory 114 may be a read-only memory, write-once read-multiple memory or read/write memory, e.g., RAM, ROM, and EEPROM, and the server 112 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 114 may be configured to store one or more software applications, such as the applications 115, and other data, such as user's private data and financial account information.

The application 115 may comprise one or more software applications comprising instructions for execution on the server 112. In some examples, the server 112 may execute one or more applications, such as software applications 115, that enable, for example, network communications with one or more components of the system 100, transmit and/or receive data, and perform the functions described herein. Upon execution by the processor 113, the application 115 may provide the functions described in this specification, specifically to execute and perform the steps and functions in the process flows described below. Such processes may be implemented in software, such as software modules, for execution by computers or other machines. The application 115 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 112 may further include a display and input devices (not shown). The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the server 112 that can be available and supported by the server 112, such as a touch-screen, keyboard, mouse, cursor-control device, touch-screen, microphone, digital camera, video recorder or camcorder. These devices may be used to enter information and interact with the software and other devices described herein.

System 100 may include one or more networks 140. In some examples, the network 140 may be one or more of a wireless network, a wired network or any combination of wireless network and wired network and may be configured to connect the switchboard system 110 with its participating service provider (e.g., 140-143) and/or client entities (e.g., 102). For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

In some examples, exemplary procedures in accordance with the present disclosure described herein can be performed by a processing arrangement and/or a computing arrangement (e.g., a computer hardware arrangement). Such processing/computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the client system 102, one or more servers associated with the switchboard system 110, and the network 140, or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. Additionally or alternatively, a storage arrangement can be provided separately from the computer-accessible medium, which can provide the instructions to the processing arrangement so as to configure the processing arrangement to execute certain exemplary procedures, processes, and methods, as described herein above, for example.

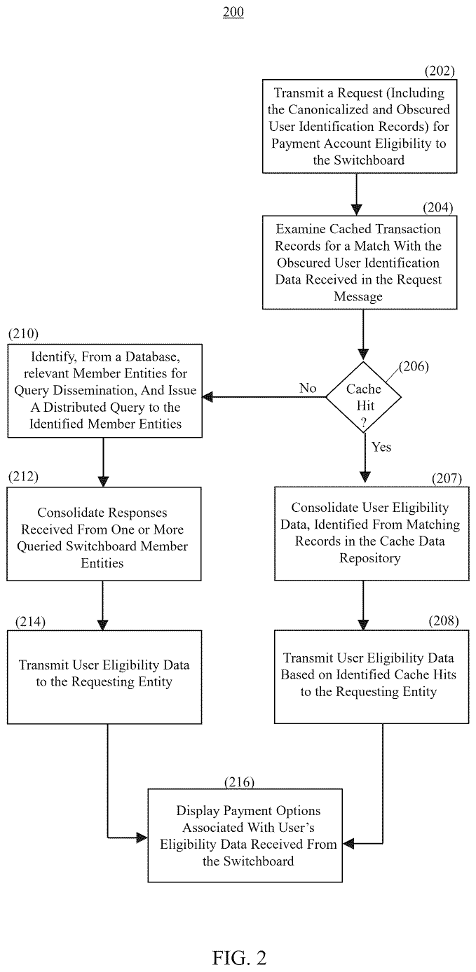

FIG. 2 illustrates an exemplary process flow diagram 200 for non-transparent querying of user eligibility, for example, with respect to contactless payment accounts available to a user at a checkout page of a merchant website. According to the exemplary process 200, at step 202, a switchboard process receives a request for eligible contactless payment accounts associated with a user identifier. In order to avoid unnecessary exposure of user's personal identification data, the user identifier may be canonicalized and obscured prior to being forwarded, in conjunction with the (eligibility) request to the switchboard system. Accordingly, at step 202 a switchboard request, including one or more obscured user identifiers (e.g., user PII) is received by a switchboard process for conducting a non-transparent query for the requested information from a plurality of participating member entities (e.g., account issuing entities).

At step 204, following receipt of the request message, the receiving switchboard process may check a cached data repository storing a records of previous contactless card transactions, the data records stored in the cache repository of the switchboard may be canonicalized and obscured in a same manner as performed by the request source device/system. At step 206 the cache repository is searched for a user identifier matching the obscured user identification record (e.g., user PII) provided in the request If a cache hit is detected at step 206, the switchboard process may identify and consolidate one or more contactless card accounts associated with the matching cache record, at step 207 and return the results, at step 208, back to client entity that had initiated the request (e.g., a request for one or more eligible contactless card accounts associated with the user). However, if a cache hit is not detected at step 206, a distributed eligibility query, for a user identified by the obscured user identification data, may be generated by the switchboard process and disseminated to the plurality of member service-providers (issuing entities) based on one or more optimization criteria, as shown in step 210. At step 212, the switchboard process receives the responses coming back from the queried member entities and consolidates the data to identify one or more user payment accounts associated with contactless payment cards. The consolidated eligibility data is then transmitted to the requesting client entity at step 214. The client system/service may then display one or more payment options associated with user's contactless payment accounts, as shown in step 216.

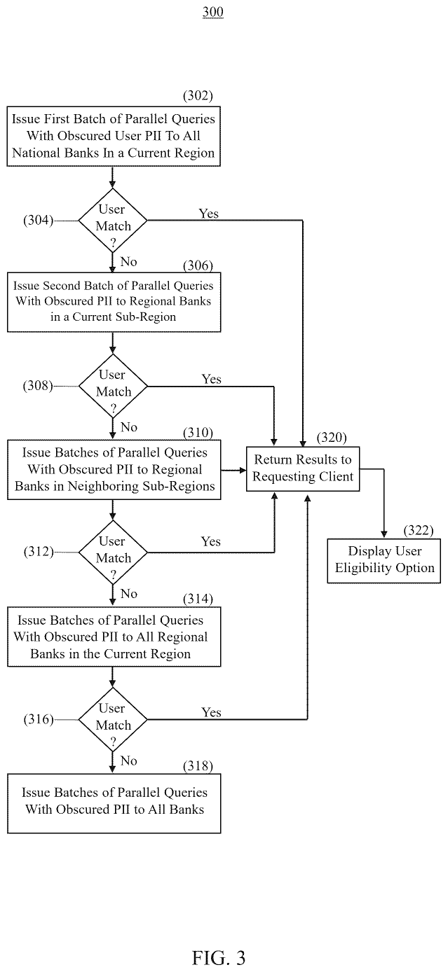

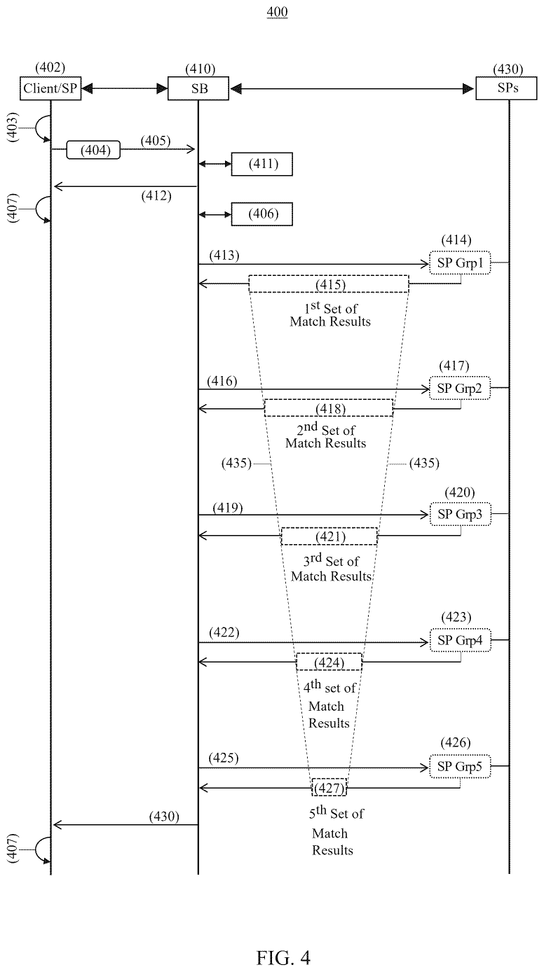

In order to optimize the distribution of the query to the relevant service provider entities participating on the switchboard, the Switchboard process may conduct a logical ordering of the recipient issuing entities based on geographic location data associated with the initial request. Accordingly, in one embodiment, the receiving switchboard process disseminated batches of parallel queries, in accordance to the determined order-with the batch size depending upon responses returned from the queried switchboard members (e.g., account issuing entities). For example, multiple null responses (e.g., no user records matching the obscured user PII included as a query index) may initiate the switchboard process to expand the geographical scope of the query distribution. In one embodiment, the switchboard process may progressively widen and/or narrow the query distribution scope based on the number of positive and/or null hits returned, from the member entities, in response to each batch of parallel queries. An example of the former and the latter implementations are provided in FIGS. 3 and 4, respectively.

FIG. 3 illustrates an exemplary optimization flow diagram 300 based on geographically widening logical ordering of query targets (e.g., a set of service-provider and/or issuer entities identified as relevant for the requested user (eligibility) data). Considering limited number of nationally-syndicated service providers (e.g., national banks) at step 302, the switchboard system may issue batches of parallel queries, with the obscured user PII, to all national banks in the region associated with the source entity. The region may be defined based on specific application and/or use case to include a range of geographical scopes (e.g., continent, country, state, etc.) At step 302, the switchboard process may issue a first batch of parallel queries with the obscured user PII data record(s) to nationally-affiliated service providers (e.g., national banks). If a match with the obscured user identification record included in the query is returned from one or more queried service providers at step 304, the switchboard may return the result to the requesting client at 320. Based on the received information, the client entity may display one or more payment checkout options to the user, at step 322.

If no matches are returned, in response to the first parallel batch of queries, from the queried group of service providers (e.g., nationally syndicated banks) in step 304, the switchboard process may broaden the search to regionally-syndicated service providers. Accordingly, the switchboard process may issue a second batch of parallel queries with obscured user PII records to a second group of service provider entities located within a current sub-region encompassing the source point of the request (e.g., location of client entity initiating the switchboard request). If a matching obscured user identification record is returned from one or more queried service providers (e.g., account issuing entity) at step 308, the result is returned to the requesting client at 320 and displayed as checkout option to the user at step 322. If no matches are returned in response to the second parallel batch of queries from the queried group of service providers (e.g., regional banks located in the current sub-region encompassing the source point) in step 308, the switchboard process may broaden the search to regionally-syndicated service providers in the neighboring sub-regions. Accordingly, at step 310 a third batch of parallel queries with the obscured user PII records is disseminated to service providers located in neighboring sub-regions of the source point.

If a matching obscured user identification record is returned from one or more queried service providers (e.g., account issuing entities) at step 312, the result is returned to the requesting client at 320 and displayed as checkout option to the user at step 322. If no matches are returned in response to the third parallel batch of queries from the queried group of service providers (e.g., regional banks located in the neighboring sub-regions of the sub-region encompassing the source point) in step 312, the switchboard process may broaden the search to include all regionally-syndicated service providers in the current region. Accordingly at step 314, a fourth batch of parallel queries with the obscured user PII records is disseminated to the service providers located in current region encompassing the source point. If a matching obscured user identification record is returned from one or more queried service providers (e.g., account issuing entity) at step 316, the result is returned to the requesting client at 320 and displayed as checkout option to the user at step 322. However, if no matches are returned, in response to the fourth parallel batch of queries, from the queried group of service providers (e.g., regional banks located in the current region encompassing the source point) in step 316, the switchboard process may broaden the search to include all service providers identified as relevant to the requested information, in the switchboard member database. Accordingly, at step 318 a batch of parallel queries may go out to all service providers identified as relevant to the queried data. In some embodiments, following a null response at step 316, the switchboard process may be configured for additional granular broadening of the query dissemination scope, prior to generating a batch of parallel queries to all service providers, identified in the switchboard member database, at step 318.

Detection of a match with obscured user identification data may require that user identification records are provided in a canonical form prior to being obscured. In some embodiment, the obscuring process may produce a hash of the clear identification record. In scenarios wherein the obscured identification record corresponds to a hashed identification record, a non-transparent query for the obscured identification record (e.g., user PII) may be based on the an exact match between the hashed identification records in a switchboard request/query and stored and/or previously cached identification records. In some embodiments, the obscuring process may produce a data record with only a limited number of characters revealed in clear text (e.g., the obscured user identification data comprises one or more clear text characters and one or more hidden characters). Therefore, a non-transparent query for the obscured user PII based on the limited number of clear text characters exposed in similarly canonicalized and obscured identification records (e.g., associated with participating service providers), may return multiple matching identification records associated with distinct users. An exemplary implementation of a progressively widening query scope of member service-provider entities (e.g., account issuers) was illustrated and discussed with respect to FIG. 3. An example of an optimization routine for narrowing the search scope in response to multiple returned matches is illustrated in FIG. 4.

FIG. 4 illustrates a timing sequence diagram 400 for an exemplary query optimization process. Exemplary implementation 400 illustrates a client entity 402 and a plurality of service provider entities 430 communicatively coupled to a switchboard (SB) system 410. The client entity may submit a request message 405 to the SB system 410 for eligible user accounts associated with a contactless transaction card. To facilitate execution of the query by SB system 410 one or more user identification record 404 are included in query 405. However, in order to facilitate the process in a non-transparent manner, user identification records are canonicalized and obscured at 403 prior to inclusion in the switchboard request message 405. Upon receiving the request message 405, a process running on the SB system performs a cached lookup of previously recorded contactless card activities received from various client and/or SB entities participating on the switchboard system 410. Accordingly, a switchboard cache repository 411 is examined for a user identifier matching the obscured user identification record 404 included in the request message 405. If a matching user identification record is identified in the cache repository 411, the requested information may be retrieved from the cache repository 411. and a response with the requested information may be returned to the client entity at 412. However, if no data record matching obscured user data 404 is found in switchboard's cache repository 411, the switchboard process may generate a query for the requested information to one or more sets of relevant service providers identified from a switchboard member database 406.

The exemplary implementation 400 involves a query optimization scheme which initially starts with a largest query scope (e.g., all regional and national service-providers identified as relevant to the requested information in the switchboard database 406), and progressively narrows the query scope in an iterative manner, to cull the number of multiple matches (on the obscured user data) that such a large search scope may return. Referring back to example 400, after identifying a set of target service-providers for querying, the switchboard system 410 generates a first batch of parallel queries 413 directed to a first group of service providers 414 (e.g., all national and regional banks identified in a switchboard member database). As noted above, larger data set of users associated with the first queried group 414 may result in a higher probability of a match hit between the obscured user data in the query and obscured identification records associated with distinct users. Therefore, a response 415 from the first query group may contain multiple match results. A second batch of parallel queries 416 may then be transmitted by the switchboard to a second group of service providers 417 (the second group of service providers may be a subset of the first group and include service provider entities within a smaller geographical region around the location of the client entity 402). The response 418 from the second query group may cull down the number of multiple match hits associated with the first query group 414.

If the response message 418 still contains multiple match entries, a third batch of parallel queries 419 may be transmitted by the switchboard to a third group of service providers 420 (the third group of service providers may be a subset of the second group and include service provider entities within a smaller geographical region around the location of the client entity 402). The response 421 from the third query group may further cull down the number of multiple match hits with the query. If the response 421 still contains multiple entries, a fourth batch of parallel queries 422 may be transmitted by the switchboard to a fourth group of service providers 423 (the fourth group of service providers may be a subset of the third group and include service provider entities within a smaller geographical region around the location of the client entity 402). The response 424 from the fourth query group may further cull down the number of multiple match hits with the query. If based on the response to the fourth batch of parallel queries, multiple matches with the obscured user identification record still remains, a fifth batch of parallel queries 425 may be transmitted by the switchboard to a fifth group of service providers 426 (the fifth group of service providers may be a subset of the fourth group and include service provider entities within a smaller geographical region around the location of the client entity 402). The response 427 from the fourth query group may further cull down the number of multiple match hits with the query.

If at any point, after each batch parallel queries issued by the switchboard a distinct match with a user identification records of a queried service provider is determined the response 430 with the requested information can be forwarded back to the client entity 402. At 407, based on the information included in the response message 430, the client entity may display one or more payment methods corresponding, for example, to the contactless payment options available to the user. With reference to example 400, the geographical scope of queried members, associated with consecutive batches of parallel queries, increasingly focuses around a narrowing geographical region encompassing the source point of the initial request 405 received by the switchboard 410. The indicator 435 illustrates a progressively narrowing envelope of solution space associated with this iterative optimization process.

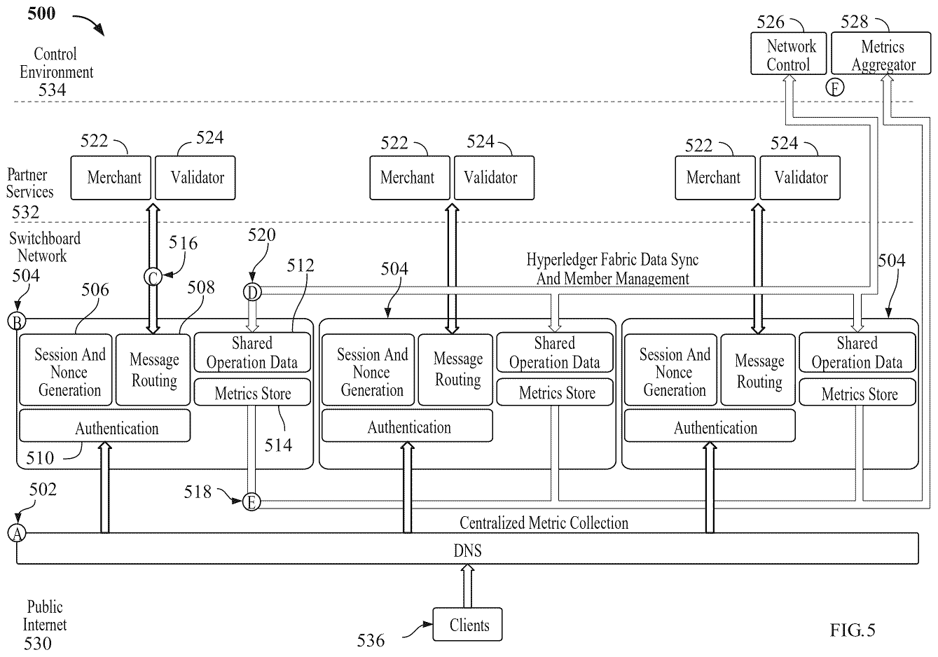

As noted above, in some embodiments of the present disclosure, the distributed management platform for identifying various user eligibility profiles (e.g., eligible contactless payment options available to the user) may be implemented by a switchboard system, an exemplary implementation of which is illustrated in FIG. 5. FIG. 5 illustrates an example of a switchboard-based system 500 in accordance with the embodiments discussed herein. The system 500 includes additional devices and systems configured to enable identity verification and other services to one or more client entities 536. Client entities 536 may correspond to a transaction-facing device or system initiating a request for user data with canonicalized and obscured user identification record(s). Specifically, system 500 may enable any number of issuer systems to provide a response with requested information to a query received from a switchboard process through a switching fabric.

In some embodiments, the switchboard system includes one or more nodes 504 configured to perform routing operations. Each switchboard node 504 may include a session and nonce generator 506, a message router 508, a process module for query dissemination and ordering algorithm for optimization of the process, an operation data store 512 (e.g., a cache repository storing recent contactless card sessions and related user data), and a metrics store 514. Further, each of the nodes may be configured the same and share configurations, but each switchboard node 504 may independently process and route messages and requests to the appropriate systems. Each of the nodes 504 is configured to act as a broker of trust between an client device 536, merchant system 522, and/or validation system 524, for example. Each switchboard node 504 is configured to route each message to the correct issuer system while maintaining data security. For example, a switchboard node 504 may route a message between an issuer system and client device while the node is not able to gain access to the private data in the message.

The switchboard system may be configured as a server system including a collection of hardware, software, and networking components that work together to provide services to the clients. Hardware components may include one or more server computers, storage devices, and network adapters. The server computers are configured to run server applications, such as those executable on each of the nodes 504. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

In some embodiments, the nodes 504 may operate in a cloud-based computing environment, e.g., a collection of hardware, software, and networking components that enable the delivery of cloud computing services. The switchboard nodes 504 and the computing services are delivered over the Internet, and they can be accessed from anywhere in the world with an Internet connection. In embodiments, a client 536 may access a switchboard node 504 through Domain Name System 502 or domain name system (DNS). The DNS 502 a hierarchical and distributed naming system for computers, services, and other resources connected to the Internet or other networks. It associates various information with domain names assigned to each registered participant. In one example, the DNS 502 may translate a name known to software executing on a client 536 to route data to one or more of switchboard node 504 of the switchboard system. In embodiments, the DNS 502 may generate into a number, such as an Internet Protocol (IP) address, an address record (A-record), or another Host name (C-name record). At a high level, the Domain Name System 502 translates known domain names to numerical Internet Protocol (IP) addresses needed for locating and identifying computer services and devices with the underlying network protocols.

In embodiments, a client 536 communicates with the switchboard system to perform one or more of the partner services 532. Once the client 536 identifies a switchboard node 504 and resolves an address to communicate with the switchboard node 504, the client 536 may send one or more messages to the switchboard node 504 to authenticate and perform one-or more operation. The switchboard node 504 includes an authentication 510 function that is configured to authenticate the client 536.

The switchboard node 504 may authorize or authenticate the client 536 or user, and the switchboard node 504 may utilize the additional components, such as the session and nonce generator 506 and message router 508, to perform control operations associated, for example, with ensuring consistent process for canonicalization and obscuring of user identification records and generation of a query for non-transparent matching of obscured user data received from a client entity. Note the client(s) 536 may never directly interact with the validator and/or issuing systems, nor vice versa. The nodes 404 brokers all communication.

In embodiments, the switchboard system may utilize a hyperledger fabric 520 to manage synchronizing the shared operation data 512 and member management across the network. The hyperledger fabric 520 is distributed ledger framework having a permissioned network model that only authorized participants can join the network and access the data that is stored on a ledger.

In embodiments, the hyperledger fabric 520 may be generated by creating one or more set of peers, an ordering service, and a channel. Once the network is created, the system 500 deploys chaincode to the network or nodes 504 permitted to access the fabric. The chaincode is the code that runs on the blockchain and executes the network control 526 and operation data 512 logic code. Once the chaincode is deployed, each of the switchboard nodes 504 is configured to invoke transactions on the blockchain to add data to the blockchain, e.g., the operational data. A switchboard node 504 or another device can query the ledger to retrieve data. The ledger is a distributed database that stores all of the data that has been added to the blockchain.

All nodes 504 keep an independently verifiable log of their actions that can be transmitted to a centralized aggregator to build a picture of overall network usage. At a central level, system 500 can manage network operation data and management and have a centralized view of network use, aggregated and abstracted to the appropriate level.

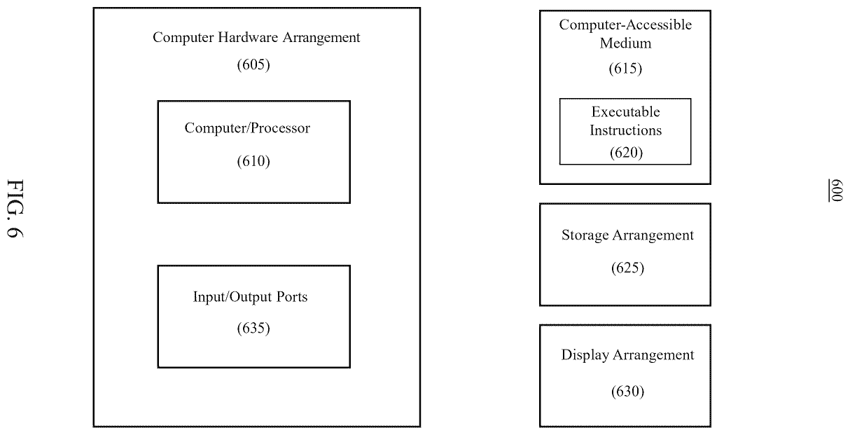

FIG. 6 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement 605). Such computer hardware arrangement 605 can be, for example entirely or a part of, or include, but not limited to, a computer and/or processor 610 that can include, for example one or more microprocessors, and use instructions stored on a computer-accessible medium (e.g., RAM, ROM, hard drive, or other storage device).

As shown in FIG. 6, for example a computer-accessible medium 615 (e.g., as described herein above, a storage device such as a hard disk, floppy disk, memory stick, CD-ROM, RAM, ROM, etc., or a collection thereof) can be provided (e.g., in communication with the computer hardware arrangement 605). The computer-accessible medium 615 can contain executable instructions 620 thereon. In addition, or alternatively, a storage arrangement 625 can be provided separately from the computer-accessible medium 615, which can provide the instructions to the computer hardware arrangement 605 so as to configure the computer hardware arrangement 605 to execute the exemplary procedures, processes, and methods, as described herein above, for example.

Further, the exemplary computer hardware arrangement 605 can be provided with or include an input and/or output ports 635, which can include, for example a wired network, a wireless network, the internet, an intranet, a data collection probe, a sensor, etc. As shown in FIG. 6, the exemplary computer hardware arrangement 605 can be in communication with an exemplary display arrangement 630, which, according to certain exemplary embodiments of the present disclosure, can be a touch-screen configured for inputting information to the computer hardware arrangement 605 in addition to outputting information from the computer hardware arrangement 605, for example. Further, the exemplary display arrangement 630 and/or a storage arrangement 625 can be used to display and/or store data in a user-accessible format and/or user-readable format.

Systems and methods described herein can provide a system and configuration establishing a match to the obscured user data from a trusted source, and implementing secure operations associated with plurality of distinct service providers (connected across a central server and/or platform), such that various user account, tied to different service providers (e.g., participating members connected to an account-linking platform), may be non-transparently queried by a switchboard process. The operations may include financial transactions (e.g., credit card and debit card transactions) whereby a user may select from a variety of financial accounts for completing a specific merchant transaction, as well as account management transactions (e.g., card refresh, card replacement, and new card addition transactions). In accordance to embodiments described herein, obscured user data in connection to a query received from a first client (e.g., first server associated with a client entity) may be applied and matched against (similarly obscured) user identification records maintained by member entities participating on the switchboard platform. Furthermore, membership transactions (e.g., joining and departing transactions), point of access transactions (e.g., building access and secure storage access transactions), transportation transactions (e.g., ticketing and boarding transactions), entertainment transactions (e.g., accessing media and/or games), and other transactions associated with a plurality of service providers may be securely facilitated via the switchboard system.

Other technical features may be readily apparent to one skilled in the art from the following figures, descriptions, and claims.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only and is not intended to be limiting.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

As used herein, the term “account” is not limited to a particular type of account. Rather, it is understood that the term “account” can refer to a variety of accounts, including without limitation, a financial account (e.g., a credit account, a debit account), a membership account, a loyalty account, a subscription account, a services account, a utilities account, a transportation account, and a physical access account. It is further understood that the present disclosure is not limited to accounts issued by a particular entity.

As used herein, the term “bank” is not limited to a particular financial institution or type of financial institution. Rather, the present disclosure includes any type of institution, financial or otherwise, involved in the performance and/or processing of transactions, including merchants, vendors, and/or other entities involving in activities where products or services are sold or otherwise provided.

As used herein, the term “merchant” is not limited to a particular merchant or type of merchant. Rather, the present disclosure includes any type of merchant, vendor, or other entity involving in activities where products or services are sold or otherwise provided.

The present disclosure includes example embodiments for determining contactless payment card eligibility for a user, but it is understood that the present disclosure is not limited to using obscured user identification data for a particular type of eligibility determination. Rather, the present disclosure encompasses other types of user eligibility criteria that may be non-transparently queried from various member entities in accordance to one or more optimization routine described herein.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A method for determining user eligibility from obscure personal data, the method comprising
transmitting, by a first client system, a data request message comprising an obscured user identification record to a switchboard communicatively coupled to a plurality of service providers;
comparing, by the switchboard, the obscured identification record with a plurality of user identifiers in a cache repository of transactional data stored by the switchboard;
transmitting, by the switchboard responsive to detecting one or more cache hits with the obscured user identification records, one or more data records associated with matching user identifiers in the cache repository, to the first client system;
responsive to detecting a cache miss, identifying, by the switchboard based on the data request message from the first client system, a list of target service providers from a member database associated with the switchboard;
ordering, by the switchboard the list of target service providers into one or more sets of service providers based on geographical proximity to a geographical location of the first client entity;
transmitting, by the switchboard, a first batch of parallel queries, with the obscured user identification record, to a first set service providers from the one or more sets of service providers;
transmitting, by the switchboard and based on a query optimization criteria determined from one or more query responses received from the first set of service providers, one or more batches of parallel queries, with the obscured user identification record, to the one or more sets of service provider;
transmitting, by the switchboard, a response message to the first client entity, the response comprising one or more query results received from one or more sets of queried service providers.

2. The method of claim 1, wherein the data request message is associated with one or more eligible contactless payment cards available to the user.

3. The method of claim 2, wherein the response message initiates the client entity to display one or more user payment options associated with the one or more eligible contactless payment cards, to the user.

4. The method of claim 1, wherein the plurality of user identifiers in the cache repository of the switchboard, have a same canonicalized format as the obscured user identification record in the data request message received from the first client entity.

5. The method of claim 4, wherein the one or more query results is provided, by one or more sets of queried service providers, based on determining a match between the obscured user identification record and one or more user identifiers stored by a service provider and associated with the same canonicalization format as the obscured user identification record.

6. The method of claim 1, wherein the cache repository of transactional data comprises a plurality of user transactional data received from one or more client entities associated with the switchboard.

7. The method of claim 1, wherein the obscured identification record corresponds to a hash of the identification records.

8. The method of claim 1, wherein the one or more batches of parallel queries are associated with a dynamic batch size, wherein the batch size is altered based on results received form a previous batch of parallel queries.

9. The method of claim 1, wherein the obscured identification data comprises one or more clear text characters and one or more hidden characters.

10. The method of claim 9, wherein a comparison between the obscured identification records included in the request message and one or more user identification records from queried service providers is based on comparison of clear text data.

11. The method of claim 1, wherein the query optimization pattern corresponds to expanding or contracting a query space relative the first batch of parallel queries.

12. The method of claim 1, wherein the user identification record comprise personally identifiable information associated with a user.

13. The method of claim 12, wherein the personally identifiable information comprises one or more of an email address, a phone number and an account number associated with the user.

14. The method of claim 1, wherein the list of target service providers corresponds to account issuing entities participating on the switchboard.

15. A system for determining user eligibility from obscured personal data, the system comprising:
a switchboard communicatively coupled with a plurality of client and service provider entities, wherein the switchboard is configured to:
receive, from a first client entity, a data request message comprising an obscured user identification record, wherein the identification record is canonicalized according to first canonicalization format prior to obscuration;
compare the obscured identification record with a plurality of user identifiers in a cache repository of transactional data stored by the switchboard;
transmit, responsive to detecting one or more cache hits with the obscured user identification records, one or more data records associated with matching user identifiers in the cache repository, to the first client entity;
responsive to detecting a cache miss, identify, based on the data request message, a list of target service providers from a member database associated with the switchboard;
order the list of target service providers into one or more sets of service providers based on geographical proximity to a geographical location of the first client entity;
transmit a first batch of parallel queries, with the obscured user identification record, to a first set service providers from the one or more sets of service providers;
transmit based on a query optimization criteria determined from one or more query responses received from the first set of service providers, one or more batches of parallel queries, with the obscured user identification record, to the one or more sets of service provider; and
transmit a response message to the first client entity, the response comprising one or more query results received from one or more sets of queried service providers.

16. The system of claim 15, wherein the data request message is associated with one or more eligible contactless payment cards available to the user.

17. The method of claim 16, wherein the response message initiates the client entity to display one or more user payment options associated with the one or more eligible contactless payment cards, to the user.

18. The method of claim 15, wherein the plurality of user identifiers in the cache repository of the switchboard, have a same canonicalized format as the obscured user identification record in the data request message received from the first client entity.

19. The method of claim 18, wherein the one or more query results is provided, by one or more sets of queried service providers, based on determining a match between the obscured user identification record and one or more user identifiers stored by a service provider and associated with the same canonicalization format as the obscured user identification record.

20. A non-transitory computer accessible medium comprising executable instructions, wherein, when executed by a switchboard, the instructions cause the switchboard to perform procedures comprising:
receiving, from a first client entity, a data request message comprising an obscured user identification record, wherein the identification record is canonicalized according to first canonicalization format prior to obscuration;
comparing the obscured identification record with a plurality of user identifiers in a cache repository of transactional data;
transmitting, responsive to detecting one or more cache hits with the obscured user identification records, one or more data records associated with matching user identifiers in the cache repository, to the first client entity;
responsive to detecting a cache miss, identifying, based on the data request message, a list of target service providers from a member database associated with the switchboard;
ordering the list of target service providers into one or more sets of service providers based on geographical proximity to a geographical location of the first client entity;
transmitting a first batch of parallel queries, with the obscured user identification record, to a first set service providers from the one or more sets of service providers;
transmitting based on a query optimization criteria determined from one or more query responses received from the first set of service providers, one or more batches of parallel queries, with the obscured user identification record, to the one or more sets of service provider; and
transmitting a response message to the first client entity, the response comprising one or more query results received from one or more sets of queried service providers.
